(19) United States
(12) Patent Application Publication
(10) Pub. No.: US 2022/0373112 A1
(43) Pub. Date: Nov. 24, 2022

(54) Cable Connector Attachment

(71) Applicant: GlobalTech Subsea, Inc., Houston, TX (US)

(72) Inventors: Blake Costanzi, Houston, TX (US); Ben Donnell, Missouri City, TX (US)

(73) Assignee: GlobalTech Subsea, Inc., Houston, TX (US)

(21) Appl. No.: 17/668,688

(22) Filed: Feb. 10, 2022

Related U.S. Application Data
(63) Continuation of application No. 16/184,241, filed on Nov. 8, 2018, now abandoned.
(60) Provisional application No. 62/583,225, filed on Nov. 8, 2017.

(51) Int. Cl. F16L 15/08; F16L 33/207

(52) U.S. Cl. CPC F16L 15/08; F16L 33/2076

(57) ABSTRACT

A cable connector attachment is provided, the attachment including at least a hose fitting, wherein said hose fitting is swedged into an associated cable and threaded into a CCP; and a set screw, wherein said set screw is inserted into the hose fitting to ensure the CCP cannot vibrate loose. Optimally the set screw is a tapered screw, so that greater force is applied to the terminus end. A braided hose is disposed in mechanical communication with a stainless hose fitting and secured using one or more fasteners. The hose is securely pressed completely inside the stainless hose fitting and then crimped, and a status signal is optimally provided by a crimp machine when a predefined crimp has been completed, thereby notifying the operator of such status. Optimally the crimp measures between about 1.1-about 1.2 inches.

### STATEMENT OF RELATED CASES

The instant U.S. non-provisional application claims the benefit of prior U.S. provisional application No. 62/583,225 filed Nov. 8, 2017, the entirety of which is commonly owned and hereby incorporated by reference.

### FIELD OF THE INVENTION

The present invention relates generally to connector cables for blow out preventers and other oilfield service equipment and in a specific though non-limited embodiment to reliably secure methods and means for attaching PBOF cables or the like to associated subsea oilfield equipment.

### BACKGROUND

Pressure balanced oil filled (PBOF) cables are employed in marine-based rig environments, and are typically disposed near the ocean floor. The connectors interface with multiple one-atmospheric and other pressure compensated vessels housing electrical interfaces disposed between a plurality of electronic controls and a plurality of sensors. The assembly is designed to supply power and communication links between a multiplex subsea control system's various points of distribution (“MUX POD”).

Design of the cable assembly and associated interface to the one-atmospheric housing is very important, as a faulty assembly can render a MUX POD or sensor inoperable and cause downtime attributable to troubleshooting the fault or defect and/or replacing or maintaining any deleteriously affected parts or systems. Even a single day of such downtime can cost an operator hundreds of thousands or even millions of dollars per day.

Toward the terminus of a connection cable, which in an illustrative embodiment might comprise a PBOF cable, a hose fitting is typically present for the purpose of connecting the hose to the cable connector plug (CCP). The prior industry standard comprised hose fittings connected to the hose by metal banding, and to the CCP by means of a mutually threaded, reciprocally disposed receptor. Water ingression into the PBOF cable through the mentioned connection would frequently cause electrical failure in the cable, thereby rendering it inoperable. Structures of the prior art also allow the CCP to vibrate loose when exposed to harsh subsea conditions.

There is therefore a longstanding but currently unmet need for more durable, reliable fittings that prevent water ingression and protect the assembly from electrical shorts and system vibrations in a manner superior to the prior art.

### SUMMARY

A cable connector attachment is provided, the attachment including at least a hose fitting, the hose fitting being swedged into an associated cable and threaded into a CCP; and a set screw, wherein the set screw is inserted into the hose fitting to ensure the CCP cannot vibrate loose.

### BRIEF DESCRIPTION OF THE DRAWINGS

FIG. 1-A shows a plan view of an example embodiment of the invention.

FIG. 1-B shows a braided hose or the like disposed in mechanical communication with a stainless hose fitting.

FIG. 2-A shows a braided hose and a plurality of suitable connector engaging nuts, each with a mated set screw assembly.

FIG. 2-B shows an example hose fully pressed into a stainless hose fitting.

### BRIEF DESCRIPTION OF SEVERAL EXAMPLE EMBODIMENTS

The present invention comprises creating a secure connection by swedging a hose fitting into the cable. The hose fitting is threaded into the CCP, and a set screw is inserted into the hose fitting to ensure the CCP cannot vibrate loose. In certain embodiments the set screw is a tapered screw, so that greater force is applied to the terminus end, thereby ensuring a tighter and more secure, reliable fit.

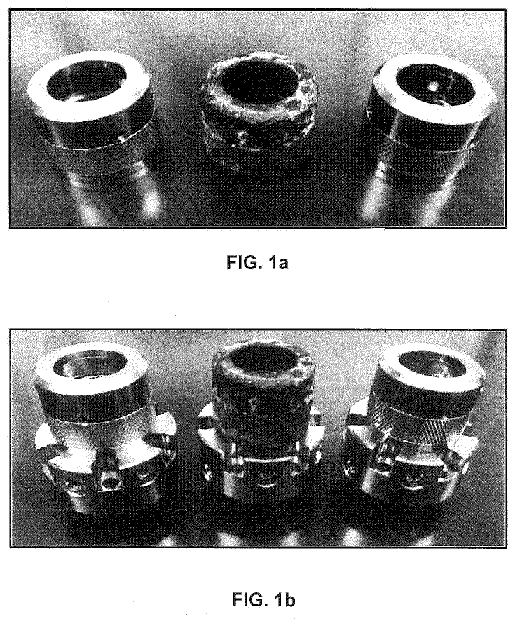

The example embodiment of FIG. 1-A shows a basic plan view of the invention. A PBOF cable is threaded into an associated CCP, and a swedged connector assures a stable seating. A set screw is drilled through the hose fitting, preferable with a tapered fit toward the terminus or distal end, so that the assembly cannot vibrate loose of the CCP. As seen in the illustrative example depicted in FIG. 1-B, a braided hose or the like is disposed in mechanical communication with a stainless hose fitting. A CCP connects the hose and fittings to an associated connector engaging nut by means of a CCP connector shell. The set screw, which in this embodiment comprises stainless steel, ensures the fitting is reliably secure and cannot shake loose due to vibration.

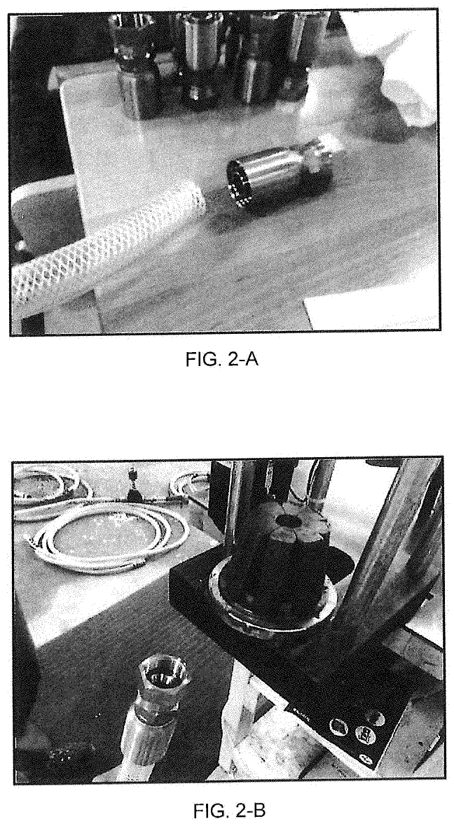

In the example depicted in FIG. 2-A, a plurality of suitable connector engaging nuts are shown, each with a mated set screw assembly. FIG. 2-A further shows a braided hose or the like, measured and cut to a desired length.

As shown in FIG. 2-B, the hose is then pressed into a stainless hose fitting. Optimally, the hose is securely pressed completely inside the stainless hose fitting. An appropriately sized die-train sizer is then located and placed on a crimping machine so as to receive the hose fitting assembly.

As shown in FIG. 3-A, the hose fitting is inserted from below into the die-train. For example, the hose fitting may be placed at the top edge of the die-train sizer where the hose fitting begins to slope downward. As seen in FIG. 3-B, an associated cover is then placed over the die-train.

As shown in FIG. 4-A, the die-train is then slid into place and the hose is crimped. In one embodiment, a signal is given by the crimp machine when a proper crimp has been completed so as to notify the operator of such. As seen in FIG. 4-B, a suitable crimp can measure between 1.1-1.2 inches.

As shown in FIG. 5-A, a process is initiated to pressure test the hose in a soak tank in order to detect any air leakage. In one example embodiment, a dead end attachment is connected to one end of the hose, as well as an air hose attachment at the opposite end. The fittings are then securely tightened by hand or otherwise. As seen in FIG. 5-B, an air hose is then attached. As shown in FIG. 5-C, the hose is then completely submerged in the soak tank. Finally, as shown in FIG. 5-D, air pressure is applied and an operator searches for air bubbles in the soak tank. The presence of air bubbles means the hose assembly has failed and cannot be used. In such event, the hose assembly is discarded and a new hose assembly must be made.

Turning now to FIGS. 6-A through 6-C, and assuming the hose assembly did not fail the soak tank test, the air hose is then used to push a rope string from one end of the hose fitting to the other. The wires are then taped together and tied to the rope. Pulling the rope will run the wire to the other end of the hose fitting, while the taping prevents the wires from running back into the hose.

Finally, as seen in FIG. 7-A through 7-D, the hose fitting is then connected to an associated CCP connector using the set screw. This step would typically be performed during a connector assembly build. In one example method, a light layer of multi-purpose bearing grease is applied to a tapered seal area of the connector end. The CCP connector and hose assembly are then set and connected as desired. The connection is the finally secured using a set screw, which should not be over-torqued as doing so will damage the threading on the CCP connector.

The foregoing specification is provided for illustrative purposes only, and is not intended to describe all possible aspects of the present invention. Moreover, while the invention has been shown and described in detail with respect to several exemplary embodiments, those of ordinary skill in the art will appreciate that minor changes to the description, and various other modifications, omissions and additions may also be made without departing from either the spirit or scope thereof.

1. A cable connector attachment, said attachment comprising:
a hose fitting, wherein said hose fitting is swedged into an associated cable and threaded into a CCP; and
a set screw, wherein said set screw is inserted into the hose fitting to ensure the CCP cannot vibrate loose.

2. The cable connector attachment of claim 1, wherein the set screw is a tapered screw, so that greater force is applied to the terminus end.

3. The cable connector attachment of claim 1, further comprising a braided hose disposed in mechanical communication with a stainless hose fitting.

4. The cable connector attachment of claim 1, further comprising a plurality of connector engaging nuts.

5. The cable connector attachment of claim 3, wherein the hose is securely pressed completely inside the stainless hose fitting and then crimped.

6. The cable connector attachment of claim 5, wherein a status signal is given by a crimp machine when a predefined crimp has been completed, thereby notifying an operator of such status.

7. The cable connector attachment of claim 6, wherein said crimp measures between about 1.1-about 1.2 inches.
